(19) United States
(12) Patent Application Publication
(10) Pub. No.: US 2010/0107401 A1
(43) Pub. Date: May 6, 2010

(54) METHOD OF MANUFACTURING MOTOR

(75) Inventors: Hideaki SUZUKI, Kyoto (JP); Kyohei ASAHI, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: Nidec Corporation, Kyoto (JP)

(21) Appl. No.: 12/612,730

(22) Filed: Nov. 5, 2009

(30) Foreign Application Priority Data
Nov. 6, 2008 (JP) 2008-285068

(51) Int. Cl. H02K 15/08

(52) U.S. Cl. 29/596

(57) ABSTRACT

A method of manufacturing a motor includes the steps of a) winding a coil wire on a stator core, and forming a stator; b) press fitting the stator formed in step a) inside the a casing; and c) sealing at least axial ends of the stator press fit inside the casing with resin.

### BACKGROUND OF THE INVENTION

1. Field of the Invention

The present invention relates to a motor and a method of manufacturing a motor. More specifically, the present invention relates to a motor that can be used in a fuel pump and a method for manufacturing a motor that can be used in a fuel pump.

2. Description of the Related Art

Fuel pumps that use a brushless motor as a driving source have been known. These fuel pumps are mounted on vehicles, for example, and are used to deliver fuel, such as gasoline, from within a fuel tank to an engine. In such a fuel pump, a motor and a pump are contained inside a tubular casing, and the motor is rotated to drive the pump. The fuel pump is located inside the fuel tank so as to be immersed in the fuel. The fuel pump delivers the fuel drawn from the pump side to the engine through a fuel pipe, after allowing the fuel to pass through a motor portion.

In recent years, biofuel having ethanol or the like as its main component has been attracting attention as a vehicle fuel that can replace gasoline. However, biofuel has a hydrophilic nature, and accordingly has higher water content than the gasoline. Therefore, the motor in the fuel pump makes contact with much more moisture when the biofuel is used. In the case of a fuel pump that uses, as its driving source, the brushless motor in which windings are arranged on a stator, it is preferable that resin sealant be provided to prevent the windings and connection members, such as busbars, which are electrically connected to the windings, from gathering rust because of the moisture in the fuel.

However, in the case where the stator of the motor is sealed with resin in the fuel pump in which the motor and the pump are contained inside the tubular casing as in the above-described fuel pump, resin protruding beyond an outer circumference of the stator would prevent insertion of the stator into the casing. Therefore, when the stator is sealed with the resin, it is necessary to have a forming die pressed against the outer circumference of the stator, in order to prevent the resin from spreading out beyond the outer circumference of the stator. However, in the case where a core of the stator is formed by a so-called straight core, which is composed of a band of a plurality of core portions each including a tooth portion which are connected together via core bending portions, a plurality of segment cores each including the tooth portion, or the like, significant variations occur in circularity or diameter of the outer circumference between different stators. Therefore, it may sometimes be difficult to have the forming die pressed against the outer circumference of every stator without a gap in between.

### SUMMARY OF THE INVENTION

According to a preferred embodiment of the present invention, a method of manufacturing a motor includes the steps of: a) winding a coil wire on a stator core, and forming a stator; b) press fitting the stator formed in step a) inside a casing; and c) sealing at least axial ends of the stator press fit inside the casing with resin.

In accordance with a method of manufacturing a motor according to a preferred embodiment of the present invention, since a stator is fit in a tubular casing, and thereafter at least axial ends of the stator are sealed with resin, it is possible to prevent the resin from spreading out beyond an outer circumference of the stator.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic cross-sectional view illustrating the structure of a fuel pump according to a first preferred embodiment of the present invention.

FIG. 2 is a schematic cross-sectional view of the fuel pump taken along line II-II of FIG. 1.

FIG. 3 is a view of a stator as seen axially from above.

FIG. 4A is a schematic view of a stator core in the form of a straight core in a process of manufacturing the stator.

FIG. 4B is a schematic view of the straight core with windings thereon, in the process of manufacturing the stator.

FIG. 4C is a schematic view of the straight core bent to substantially assume the shape of a tube, in the process of manufacturing the stator.

FIG. 5A is a schematic diagram illustrating how the stator is press fit in a casing in a resin sealing step.

FIG. 5B is a schematic diagram illustrating how a forming die is inserted within an inner circumference of the stator in the resin sealing step.

FIG. 5C is a schematic diagram illustrating how the stator is placed between forming dies and sealed with resin in the resin sealing step.

FIG. 6A is a schematic view of a segment core in a process of manufacturing a stator according to a second preferred embodiment of the present invention.

FIG. 6B is a schematic view of the segment core with a winding thereon in the process of manufacturing the stator.

FIG. 6C is a schematic view of segment cores which have been joined to one another so as to substantially assume the shape of a tube in the process of manufacturing the stator.

### DETAILED DESCRIPTION OF THE PREFERRED EMBODIMENTS

Hereinafter, preferred embodiments of the present invention will be described in detail with reference to the accompanying drawings. Note that preferred embodiments described below are merely preferred embodiments illustrative of the present invention, and should not be construed as limiting the present invention, its applications, or the range of its uses.

### Motor Structure

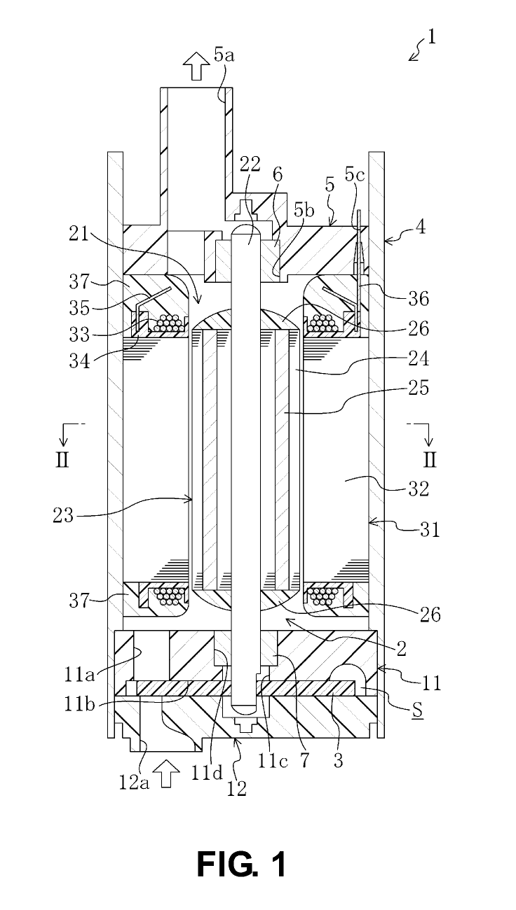

FIG. 1 is a schematic diagram illustrating the structure of a fuel pump 1 including a motor 2 according to the first preferred embodiment of the present invention. The fuel pump 1 is preferably located inside a fuel tank arranged to store fuel, such as gasoline or diesel fuel, to be immersed in the fuel. The motor 2 is driven to rotate an impeller 3, so that the fuel pump 1 draws the fuel into a casing 4 and then discharges the fuel. As a result, the fuel is delivered to an engine through a fuel pipe.

Specifically, in the fuel pump 1, the motor 2 and the impeller 3 are contained inside the casing 4, which is substantially tubular and preferably made of metal. The impeller 3 is connected to a rotating shaft 22 of the motor 2, and the motor 2 and the impeller 3 are arranged one above the other along an axial direction. At an axial end of the motor 2, the casing 4 is covered with an outlet side cover member 5 that is preferably made of resin. At an end on the impeller 3 side, the casing 4 is covered with a pump casing 11 and a pump cover 12. The pump casing 11 and the pump cover 12 together define a pump chamber S. The pump chamber S accommodates the impeller 3.

The outlet side cover member 5 is preferably defined by a substantially disc-shaped resin member. The outlet side cover member 5 has provided therein an outlet port 5a which defines a through aperture extending along the axial direction, and a recessed portion 5b arranged to accommodate a bearing 6. The bearing 6 supports an end (hereinafter referred to as an “upper end”) of the rotating shaft 22 of the motor 2 to allow rotation of the rotating shaft 22. In addition, the outlet side cover member 5 has provided therein a busbar aperture 5c arranged to allow an external busbar 36 that extends from a stator 31 of the motor 2 to pass there through to an outside of the fuel pump 1.

Each of the pump casing 11 and the pump cover 12 is defined by a substantially disc-shaped resin member. The pump casing 11 and the pump cover 12 are arranged inside the casing 4 such that the pump casing 11 is located axially inward of the pump cover 12. The pump cover 12 has provided therein an inlet port 12a which defines a through hole extending along the axial direction to communicate with the pump chamber S. The pump casing 11 has provided therein an inlet channel 11a which defines a through aperture extending along the axial direction to communicate with the pump chamber S. Thus, the interior of the casing 4 communicates with the outside of the fuel pump 1 through the inlet port 12a, the pump chamber S, and the inlet channel 11a.

On a surface of the pump casing 11 on the pump cover 12 side, a recessed portion 11b and a through hole 11c are provided. The recessed portion 11b defines the pump chamber S. The rotating shaft 22 of the motor 2 passes through the through hole 11c. On a surface of the pump casing 11 on the motor 2 side, an expanded hole portion 11d arranged to accommodate a bearing 7 is provided. The bearing 7 supports the other end (hereinafter referred to as a “lower end”) of the rotating shaft 22 to allow for rotation of the rotating shaft 22.

The impeller 3 is preferably shaped in the form of a propeller, for example. The lower end of the rotating shaft 22 is connected to a substantially central portion, in plan view, of the impeller 3. The impeller 3 is shaped so that the fuel will be drawn into the interior of the casing 4 through the inlet port 12a upon rotation of the impeller 3. Thus, the rotation of the impeller 3 causes the fuel to be drawn into the pump chamber S through the inlet port 12a, and then the fuel flows into the interior of the casing 4 of the fuel pump 1 through the inlet channel 11a. The fuel drawn into the interior of the casing 4 flows in a gap between a rotor 21 of the motor 2 and the stator 31, and is discharged to the outside of the fuel pump 1 through the outlet port 5a provided in the outlet side cover member 5 (see hollow arrows in FIG. 1).

The motor 2 includes the rotor 21, which is preferably substantially cylindrical, and the stator 31, which is preferably substantially tubular. The stator 31 is arranged to surround the rotor 21. The motor 2 is thus structured as a so-called brushless motor. Specifically, permanent magnets 25 are arranged inside the rotor 21, while windings 33 are provided inside the stator 31. In the motor 2, the windings 33 in the stator 31 are energized with a specified timing to control the rotation of the rotor 21.

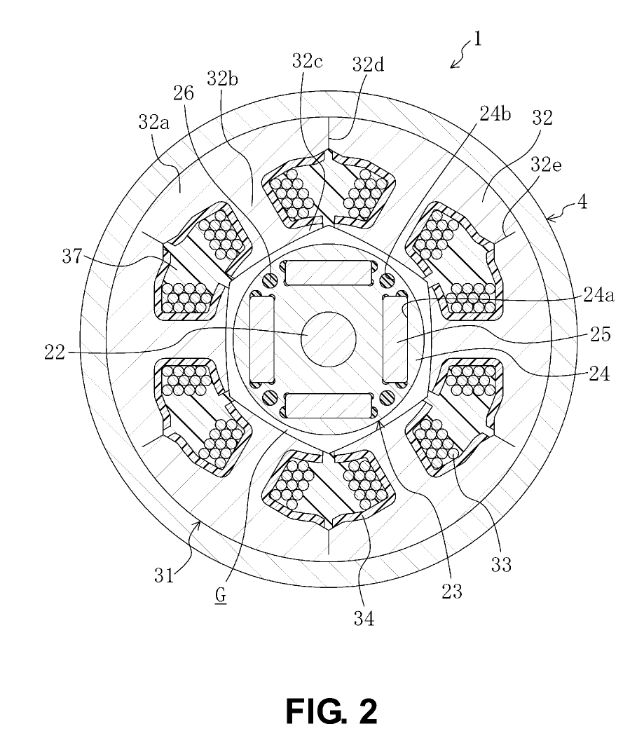

The rotor 21 includes the rotating shaft 22 and a rotor core portion 23. The rotating shaft 22 is supported by the bearings 6 and 7 at the both ends thereof such that the rotating shaft 22 is rotatable. The rotor core portion 23 is attached to the rotating shaft 22 to rotate integrally with the rotating shaft 22. The rotor core portion 23 includes a substantially tubular rotor core 24 and the permanent magnets 25. The rotor core 24 is preferably defined by laminated steel sheets, but any other desirable rotor core type could be provided. The permanent magnets 25 are provided within the rotor core 24. As illustrated in FIG. 2, the rotor core portion 23 preferably has four, for example, slots 24a arranged to surround the rotating shaft 22 provided therein, and each of the slots 24a is preferably substantially in the shape of a rectangle in cross section. The permanent magnets 25 are inserted in each of the slots 24a.

As illustrated in FIG. 1, preferably both axial ends of the rotor core portion 23 are covered with resin 26 so that the permanent magnets 25 may not be removed from the rotor core portion 23. The resin 26 is preferably, fuel-tolerant. Since the both axial ends of the rotor core portion 23 are covered with the resin 26, the permanent magnets 25 are prevented from gathering rust and from making contact with the fuel flowing through inside the motor 2. In addition, the resin 26 is preferably arranged to substantially assume the shape of a hemisphere, with the thickness thereof gradually increasing toward a center of the rotation of the rotor core portion 23. This contributes to reducing channel resistance at the axial ends of the rotor core portion 23 when the fuel flows through inside the motor 2, resulting in an efficient flow of the fuel. Note that the resin 26 may be any resin material that is neither hydrolyzed nor dissolved in a solvent in the fuel. Examples of such resin materials include polyphenylene sulfide (PPS), polyacetal (POM), and polyphthalamide (PPA), for example. Although the resin 26 is arranged to substantially assume the shape of a hemisphere in the present preferred embodiment, this is not essential to the present invention. The resin 26 may be arranged to substantially assume the shape of a cone in other preferred embodiments of the present invention.

As illustrated in FIG. 2, the rotor core portion 23 preferably includes through holes 24b which are arranged to serve as so-called flux barriers. The through holes 24b are arranged between each pair of adjacent slots 24a, and serve to prevent magnetic flux of any two adjacent permanent magnets 25 from interfering with each other to cause a short circuit. Each of the through holes 24b extends through the rotor core 24 in the axial direction. Accordingly, when the both axial ends of the rotor core portion 23 are sealed with the resin 26 as described above, the through holes 24b are filled in with the resin 26. This results in union of the resins 26 on the both axial ends of the rotor core portion 23 through the resin 26 inside each of the through holes 24b, resulting in increased strength of adhesion of the resins 26 to both axial ends of the rotor core 24.

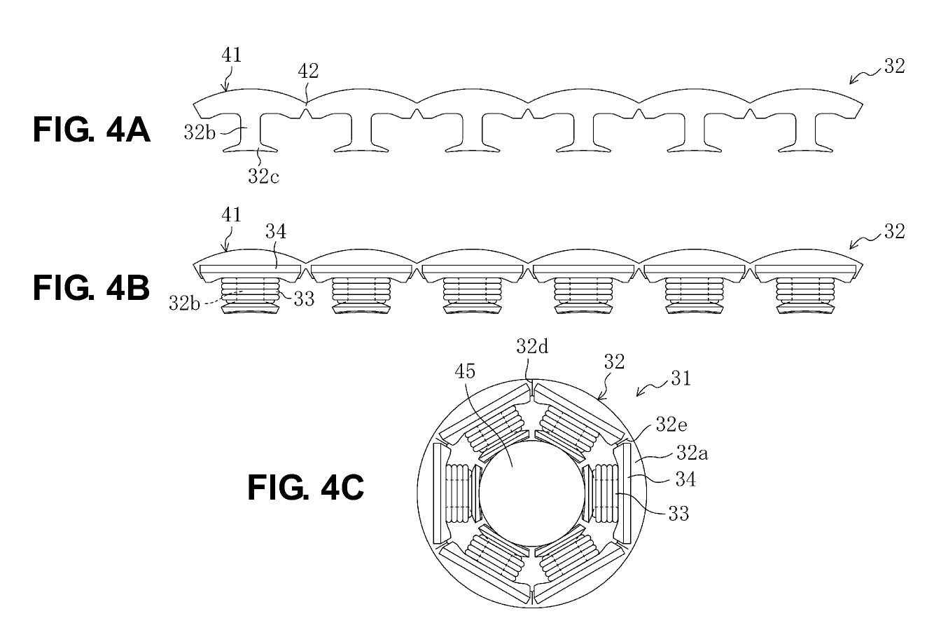

As illustrated in FIGS. 1 and 2, the stator 31 preferably includes a substantially tubular stator core 32 and the windings 33. The stator core 32 is preferably defined by laminated steel sheets. Specifically, the stator core 32 includes a substantially annular core back portion 32a and a plurality of tooth portions 32b. In the present preferred embodiment, the stator core 32 preferably has six, for example, tooth portions 32b. Each of the tooth portions 32b protrudes radially inward from an inner circumference of the core back portion 32a. An expanded portion 32c spreading in a circumferential direction is provided as a tip portion of each of the tooth portions 32b, so that each of the tooth portions 32b as a whole substantially assumes the shape of the letter “T” in cross section. In addition, a coil wire is wound around each of the tooth portions 32b to form the windings 33. Note that the stator core 32 is defined by a so-called straight core composed of band of core portions 41 (shown in FIG. 4A), each including a single tooth portion 32b, connected together, and that this straight core is bent to assume a tubular shape. In FIG. 2, reference symbol 32d designates a joint of the straight core, and reference symbol 32e designates seams between adjacent core portions 41 resulting from the bending of the straight core.

The stator 31 is arranged to define a gap G between an outer circumferential surface of the rotor 21 and the expanded portions 32c of the tooth portions 32b. A surface of each expanded portion 32c opposite to the rotor 21 has a larger radius of curvature than that of the outer circumferential surface of the rotor 21, so that the gap G is narrowest at a central portion of the expanded portion 32c and widest at both ends of the expanded portion 32c. Since the gap G is wider at the both ends of the expanded portion 32c of each tooth portion 32b than at the central portion of the expanded portion 32c of each tooth portion 32b, a channel arranged to permit the fuel to flow in the gap G is widened at both ends in a width direction of each expanded portion 32c, while at the same time the central portion of each expanded portion 32c is located closer to the rotor 21 where the magnetic flux is densest. This leads to a more efficient flow of the fuel in the motor 2, and a decreased reduction in magnetic flux density due to the widened gap G, which in turn prevents a significant reduction in motor performance.

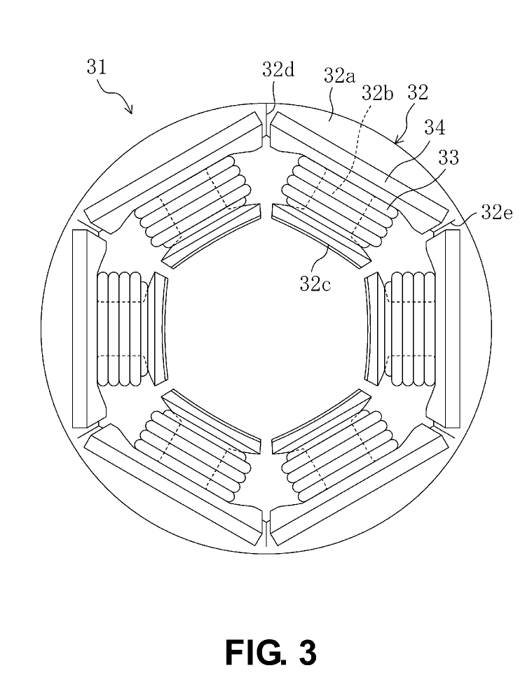

As illustrated in FIG. 3, each tooth portion 32b is preferably covered with an insulating member 34 from a radially outer circumference of the expanded portion 32c to an inner circumference of the core back portion 32a. The coil wire is wound around the tooth portion 32b with the intervening insulating member 34. Each of the windings 33 is connected to a busbar 35, preferably made of copper, to enter U, V, or W phase when energized. Each winding 33 is connected to a control circuit (not shown) through the external busbar 36, made of copper, connected to the busbar 35.

As with the rotor 21, both axial ends of the stator 31 are also preferably covered with resin 37. The resin 37 is preferably fuel-tolerant. At the both axial ends of the stator 31, the insulating members 34, the windings 33, and the busbars 35 and 36 are sealed with the resin 37. Moreover, an axially through space is defined between each pair of adjacent tooth portions 32b, and these spaces are also filled in with the resin 37. The sealing of the both axial ends of the stator 31 with the resin 37 prevents the metallic members, such as the copper busbars 35 and 36, the coil wire, whose surface coating is partially removed to establish its connection with the busbars 35 and 36, and the steel sheets of the stator core 32, from making contact with the fuel when the fuel flows in the motor 2. This prevents these metallic members from gathering rust because of the fuel. Moreover, since the space between each pair of adjacent tooth portions 32b is also sealed with the resin 37, the coil wire and the stator core 32 are prevented from making contact with the fuel. Note that the resin 37 may be any resin material that is fuel-tolerant. Examples of such resin materials include PPS resin, POM resin, and PPA resin.

### Method of Manufacturing Motor

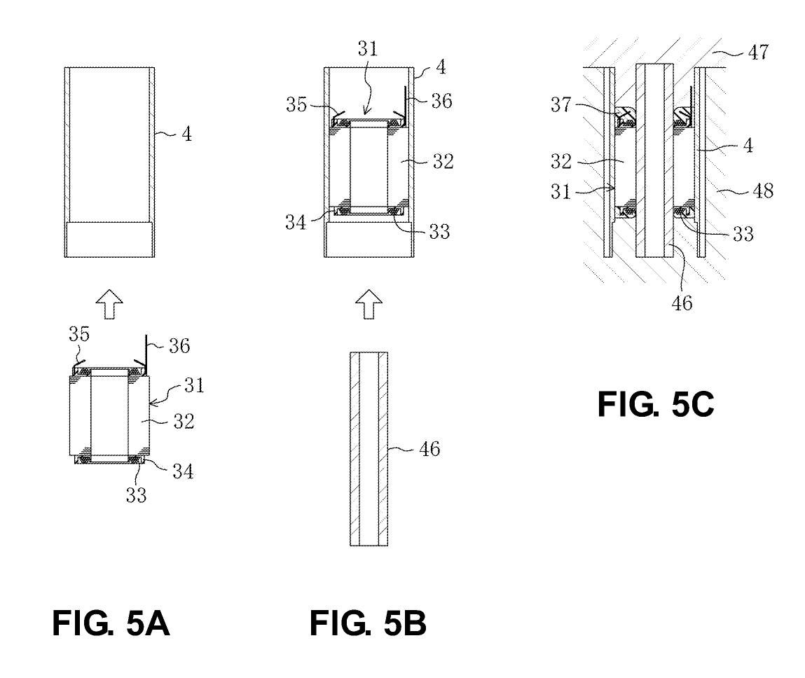

A method of manufacturing the motor 2 will now be described below with reference to FIGS. 4A to 5C.

The stator core 32 of the motor 2 is a so-called straight core composed of the band of the core portions 41, each including a single tooth portion 32b, connected together via core bending portions 42. As illustrated in FIG. 4C, the straight core is bent at the core bending portions 42 to form the substantially tubular stator core 32. Specifically, an arc length of each core portion 41 is equal, and the band of the core portions 41 is bent at the core bending portions 42 to form the core back portion 32a.

FIGS. 4A-4C illustrate a method of forming the stator 31 by using such a straight core. First, the stator core 32 is manufactured in the form of the straight core as illustrated in FIG. 4A. Then, as illustrated in FIG. 4B, the insulating member 34 is put on the tooth portion 32b of each core portion 41, and the coil wire is wound on the insulating member 34 to form the winding 33. Then, a substantially cylindrical mandrel 45 is placed at a position corresponding to an inside of the stator 31 in relation to the stator core 32 with the windings 33 thereon. Then, the stator core 32 is bent at the core bending portions 42 so that a top of the expanded portion 32c of each tooth portion 32b is brought into contact with an outer circumferential surface of the mandrel 45. These steps result in the substantially tubular stator 31 as illustrated in FIG. 4C. Notice here that, in the situation where the stator 31 is substantially in the shape of a tube as illustrated in FIG. 4C, the core bending portions 42 become the seams 32e in FIG. 4C, and that the both ends of the straight core become the joint 32d in FIG. 4C. At the joint 32d, the ends of the straight core are joined together by welding or other joining method or members, for example.

In the case where the above-described method of manufacturing stators is adopted, it is possible to wind the coil wire around the tooth portions 32b when the stator core 32 is in the form of the straight core, even when adjacent tooth portions 32b are very close to each other as in the case of the stator 31 according to the present preferred embodiment, and an improvement can be achieved in workability at the time of wire winding. However, in the case where the mandrel 45 is placed at the position corresponding to the inside of the stator 31, and the straight core is bent as described above, an inner side of the stator 31 defines a reference surface. Accordingly, although an inner circumferential surface of the stator 31 can assume the shape of a circle with high precision, a same level of high precision cannot be achieved in circularity or diameter of the outer circumference of the stator 31.

Meanwhile, in the case where the windings 33, the busbars 35 and 36, and so on are sealed with the resin as in the present preferred embodiment, low precision in the outer diameter of the stator 31 would result in a gap between the stator 31 and a forming die at the time of resin molding, and the resin would spread out beyond the outer circumference of the stator 31.

As such, the method of manufacturing the motor in accordance with the present preferred embodiment uses the casing 4 to prevent the resin from spreading out beyond the outer circumference of the stator 31 as illustrated in FIGS. 5A-5C.

Specifically, as illustrated in FIG. 5A, the stator 31 is preferably first press fit in the substantially tubular, metallic casing 4. Then, as illustrated in FIG. 5B, a hollow forming die 46 substantially in the shape of a hexagon in cross section is inserted within the inner circumference of the stator 31. In this situation, forming dies 47 and 48 are set from above and below, and molten resin is injected to an axial end of the stator 31. As a result, the both axial ends and inside of the stator 31 are sealed with the resin 37.

The above method prevents the resin from spreading out beyond the outer circumference of the stator 31 since the casing 4 is embedded in the outer circumference of the stator 31, even when the precision is low in the circularity or diameter of the outer circumference of the stator 31. Moreover, since the forming die 46 substantially in the shape of a hexagon in cross section is inserted within the inner circumference of the stator 31, the resin is prevented from spreading beyond the inner circumference of the stator 31 as well.

Still further, since the sealing with the use of the resin 37 is performed after the stator 31 is press fit in the casing 4, fine shavings and so on that result from the press fitting of the stator 31 in the casing 4 can be confined within the resin 37. This prevents the shavings from being scattered in the motor 2.

Here, regarding the above-described method of manufacturing the motor 2, step a) corresponds to the step of winding the coil wire around the tooth portions 32b of the stator core 32 formed by the straight core to form the windings 33, and thereafter bending the stator core 32 to shape it into a tubular form; step b) corresponds to the step of press fitting the tubular stator 31 in the casing 4; and step c) corresponds to the step of sealing the axial ends of the stator 31 with the resin in the situation where the casing 4 and the stator 31 are held by the forming dies 46 to 48.

As described above, according to the present preferred embodiment, the stator 31 obtained by bending the straight core is press fit in the casing 4 of the fuel pump 1, and thereafter the both axial ends of the stator 31 are sealed with the resin 37. This prevents the occurrence of a gap between the stator 31 and the casing 4 even if the precision is low in the outer diameter of the stator 31, and prevents the resin from spreading beyond the outer circumference of the stator 31.

Moreover, the placing of the forming die 46 inside the inner circumference of the stator 31 when the both axial ends of the stator 31 are sealed with the resin 37 prevents the resin from spreading beyond the inner circumference of the stator 31.

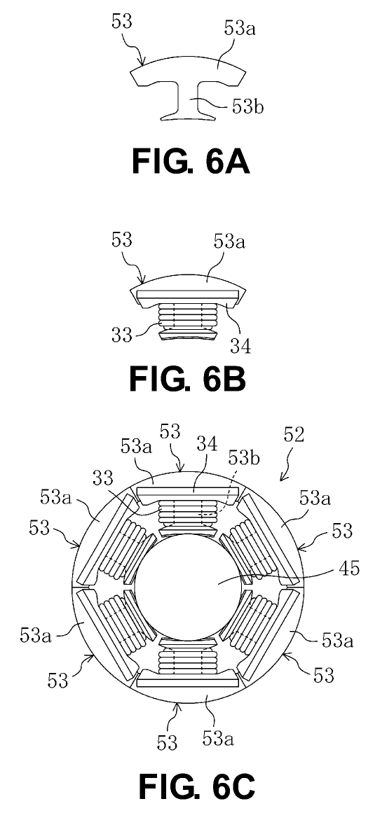

Next, a second preferred embodiment of the present invention will now be described below with reference to FIGS. 6A-6B. As illustrated in FIG. 6A, the present preferred embodiment is preferably substantially the same as the first preferred embodiment except that a stator core 52 is formed by a plurality of segment cores 53. Accordingly, like portions are designated by like reference numerals and the following description focuses on the difference.

Specifically, the plurality of segment cores 53 are joined to one another at core back portions 53a to form the stator core 52. Each of the segment cores 53 includes a tooth portion 53b. As illustrated in FIG. 6B, in connection with the stator core 52, the insulating member 34 is put on the tooth portion 53b of each segment core 53, and thereafter the coil wire is wound on the insulating member 34 to form the winding 33. Then, as illustrated in FIG. 6C, the plurality of segment cores 53, each with the winding 33 thereon, are arranged to form a ring shape, and each pair of adjacent core back portions 53a are joined together by welding to obtain the stator.

The above arrangement allows the winding 33 to be put on each segment core 53 as illustrated in FIG. 6B before the segment cores 53 are joined together, even when adjacent tooth portions 53b of the stator core 52 are very close to each other as illustrated in FIG. 6C. This prevents a reduction in workability when the windings 33 are put on the segment cores 53.

As illustrated in FIG. 6C, when the segment cores 53 are joined together by welding at the core back portions 53a, the substantially cylindrical mandrel 45 is arranged so that an inner circumference of the tooth portions 53b of the segment cores 53 is in contact therewith. That is, in the present preferred embodiment the inner circumference of the stator core 52 defines a reference surface and significant variations are likely to occur in the diameter of the outer circumference between separate stator cores 52. As such, the use of the manufacturing method as described above with reference to the first preferred embodiment prevents the resin from spreading beyond the outer circumference of the stator core 52.

While preferred embodiments of the present invention have been described above, note that the present invention is not limited to the above-described preferred embodiments, but that various modifications are possible.

The hollow forming die 46 substantially in the shape of a hexagon in cross section is preferably used when the both axial ends of the stator 31 are sealed with the resin, but this is not essential to the present invention. For example, the mandrel may be used in place of the forming die 46. In this case, it is preferable that the mandrel be not in the shape of a cylinder but substantially in the shape of a hexagon in cross section as with the forming die 46. This eliminates the need to prepare the additional forming die to be inserted within the inner circumference of the stator 31, when the both axial ends of the stator 31 are sealed with the resin. This contributes to reduced cost and also eliminates the need for the operation of inserting the forming die, leading to improved workability.

In the above-described preferred embodiments, the casing 4 of the fuel pump 1 preferably is substantially tubular and preferably made of metal. Note, however, that the casing may be made of any material that allows its outer diameter to be formed more precisely than that of the stator core. Also note that the casing may be in any shape that allows the stator to be press fit therein.

Further, in the above-described preferred embodiments, the outlet side cover member 5, the pump casing 11, and the pump cover 12 are preferably defined by resin members. However, this is not essential to the present invention. The outlet side cover member 5, the pump casing 11, and the pump cover 12 may be formed by other types of members than the resin members. Examples of such other types of members include metallic members such as aluminum die-cast members.

Still further, the above-described preferred embodiments are directed to the method of manufacturing the motor 2 preferably for use in the fuel pump 1. Note, however, that this is not essential to the present invention. Other embodiments of the present invention may be applied to motors designed for other applications, as long as both axial ends of the motor are sealed with resin.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of manufacturing a motor including a tubular casing and a stator, the stator including a tubular stator core contained inside the tubular casing and a plurality of windings defined by a coil wire wound on the stator core, the method comprising the steps of:
a) winding the coil wire on the stator core to form the stator;
b) press fitting the stator formed in step a) inside the casing; and
c) sealing at least axial ends of the stator press fit inside the casing with resin.

2. The method according to claim 1, wherein the stator core is a straight core including a band of core portions connected together via core bending portions, each of the core portions including a tooth portion; and
in step a), the coil wire is wound around the tooth portions of the straight core, and thereafter the straight core is bent at the core bending portions to form the stator to have a tubular shape.

3. The method according to claim 2, wherein
in step a), when the stator is formed, a mandrel is placed at a position corresponding to an inside of the stator, and the stator core is formed into the tubular shape such that a tip portion of each tooth portion is brought into contact with the mandrel; and
in step c), the axial ends of the stator are sealed with the resin after a forming die is inserted within an inner circumference of the stator.

4. The method according to claim 3, wherein
in step c), at least the axial ends of the stator are sealed with the resin when the mandrel used in step a) is kept inserted within the inner circumference of the stator and used as the forming die.

5. The method according to claim 1, wherein the stator core is formed by a plurality of segment cores each including a tooth portion; and
in step a), the coil wire is wound around the tooth portions of the segment cores, and thereafter the segment cores are joined to one another to form the stator in a tubular shape.

6. The method according to claim 5, wherein
in step a), when the stator is formed, a mandrel is placed at a position corresponding to an inside of the stator, and the stator core is formed in a tubular shape such that a tip portion of each tooth portion is in contact with the mandrel; and
in step c), at least the axial ends of the stator are sealed with the resin when a forming die is inserted within an inner circumference of the stator.

7. The method according to claim 6, wherein in step c), at least the axial ends of the stator are sealed with the resin in when the mandrel used in step a) is kept inserted within the inner circumference of the stator and used as the forming die.
